(19) United States
(12) Patent Application Publication
(10) Pub. No.: US 2024/0151882 A1
(43) Pub. Date: May 9, 2024

(54) INTEGRATED OPTICAL ASSEMBLY INCLUDING A TUNABLE LENS ELEMENT

(71) Applicant: Meta Platforms Technologies, LLC, Menlo Park, CA (US)

(72) Inventors: Shaomin Xiong, Newark, CA (US); Lidu Huang, Danville, CA (US)

(21) Appl. No.: 18/498,812

(22) Filed: Oct. 31, 2023

Related U.S. Application Data
(60) Provisional application No. 63/423,644, filed on Nov. 8, 2022.

(51) Int. Cl. G02B 3/14; G02B 7/04

(52) U.S. Cl. CPC G02B 3/14; G02B 7/04

(57) ABSTRACT

An integrated optical assembly with one or more integrated tunable lens elements within a lens barrel is described. The integrated optical assembly may be a part of an imaging device. The integrated optical assembly may include an optical element, a tunable lens element, and a lens barrel. The tunable lens element includes a tunable lens that is affixed to and communicatively coupled to a mount and is configured to adjust its optical power in accordance with an applied signal. The lens barrel is configured to hold the tunable lens element in optical series with at least one other optical element within the lens barrel. The lens barrel includes an integrated electrode that communicatively couples the mount to a controller which supplies the applied signal.

### CROSS-REFERENCE TO RELATED APPLICATIONS

This application claims the benefit of U.S. Provisional Application No. 63/423,644, filed Nov. 8, 2022, which is incorporated by reference.

### FIELD OF THE INVENTION

This disclosure relates generally to camera optical systems, and more specifically to an integrated optical assembly including one or more tunable lens elements.

### BACKGROUND

Wearable devices (e.g., headsets) may include one or more cameras. But as the form factor of these devices is very small and they are generally subject to strict power requirements, the optical assembly of these cameras is generally quite basic. For example, these types of optical assemblies typically are a single wide-angle lens that lacks an ability to dynamically adjust its focus.

### SUMMARY

In accordance with one or more aspects of the disclosure, an integrated optical assembly that includes one or more tunable lens elements is described. The integrated optical assembly may be a part of an imaging device. The integrated optical assembly may include one or more optical elements, one or more tunable lens elements, and a lens barrel. A tunable lens element includes a tunable lens and a mount. The tunable lens is affixed to and communicatively (e.g., electrically) coupled to the mount and is configured to adjust its optical power in accordance with an applied signal. The lens barrel is configured to hold the one or more tunable lens elements in optical series with the one or more optical elements within the lens barrel. The lens barrel may include one or more integrated electrodes that communicatively couple mounts of the one or more tunable lens elements to a controller which supplies the applied signal.

In some embodiment an integrated optical assembly is described. The integrated optical assembly includes a tunable lens element and a lens barrel. The tunable lens element includes a tunable lens that is affixed to and communicatively coupled to a mount and is configured to adjust its optical power in accordance with an applied signal. The lens barrel is configured to hold the tunable lens element in optical series with at least one other optical element (e.g., an active optical element or a passive optical element) within the lens barrel. The lens barrel includes an integrated electrode. The integrated electrode may communicatively couple the mount to a controller which supplies the applied signal.

In some embodiments a lens barrel is described. The lens barrel is configured to hold an optical element (e.g., an active optical element or a passive optical element) and a tunable lens element in optical series with each other within the lens barrel. The lens barrel includes an integrated electrode. The integrated electrode may be configured to communicatively couple a mount of the tunable lens element to a controller that controls a tunable lens of the tunable lens element.

In some embodiments an imaging device is described. The imaging device may include a lens, a tunable lens element, a sensor assembly, and a lens barrel. The tunable lens element includes a tunable lens that is affixed to and communicatively coupled to a mount and is configured to adjust its optical power in accordance with an applied signal. The lens barrel is configured to hold the lens and the tunable lens element in optical series with each other within the lens barrel such that light passing through the lens and the tunable lens focuses on the sensor assembly. The lens barrel includes an integrated electrode. The integrated electrode may communicatively couple the mount to a controller which supplies the applied signal.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a perspective view of an example imaging device with an integrated optical assembly having one or more integrated tunable lenses, according to one or more embodiments.

FIG. 3A is a perspective view of the integrated optical assembly of FIG. 2.

FIG. 3B is a cross section of the integrated optical assembly of FIG. 3A.

FIG. 3C is a perspective view of a tunable lens element, according to one or more embodiments.

FIG. 4 is an example process for assembling the integrated optical assembly of FIG. 3 A.

FIG. 5 is an example configuration of tunable lens elements that have a range of optical powers that includes both negative and positive values, according to one or more embodiments.

FIG. 6 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of an integrated optical assembly that include one or more tunable lens elements are described. The integrated optical assembly may be a part of an imaging device. The integrated optical assembly may include one or more optical elements including at least one tunable lens element and a lens barrel. The one or more optical elements may passive (e.g., lens, aperture, etc.) or active (e.g., tunable lens element). A tunable lens element includes a tunable lens and a mount. The tunable lens is affixed to and communicatively coupled to the mount and is configured to adjust its optical power in accordance with an applied signal. The lens barrel is configured to hold one or more optical elements including the at least one tunable lens element in optical series with each other within the lens barrel. The lens barrel includes one or more integrated electrodes that communicatively couple the one or more tunable lens elements to a controller which supplies the applied signal.

The lens barrel includes a plurality of locations for optical elements. The plurality of locations may include locations for passive optical elements (e.g., lenses), locations for active optical elements (e.g., tunable lens element), or some combination thereof. A location for an active optical element includes one or more coupling areas. A coupling area may be, e.g., a contact pad that is part of (or coupled to) one or more of the integrated electrodes. An active optical element may be placed within the lens barrel in a location for an active optical element and be communicatively coupled to, e.g., a controller, via the one or more coupling areas as they are part of (or coupled to) the one or more integrated electrodes. In this manner, active optical elements may be integrated into a single monolithic lens barrel.

In contrast, conventional optical systems with tunable lenses house the tunable lens in a lens barrel that is separate from lens barrels that include passive optical elements. The multiple lens barrels are then coupled together resulting in a multi-barrel system. Multi-barrel systems may have a more complex (and likely expensive) manufacturing process. Moreover, such multi-barrel systems tend to be more sensitive to mechanical shock, drop fails, electrical faults, etc., than the single lens barrel system described.

Moreover, structure of the lens barrel described is such that it can be compact and used in devices (e.g., cameras) that require a small form factor. In contrast, conventional cameras may have passive optical elements within the lens barrel and a tunable lens outside of the lens barrel which results in a layout with a larger overall length (along the optical axis) than what is described. Moreover, alignment in conventional systems is more difficult as the tunable lens which is separate from the lens barrel has to be aligned to the lenses within lens barrel. In contrast, alignment is much easier for the lens barrel with integrated tunable lens — as the lens barrel itself holds the one or more lenses and the one or more tunable lenses in the correct position relative to each other.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

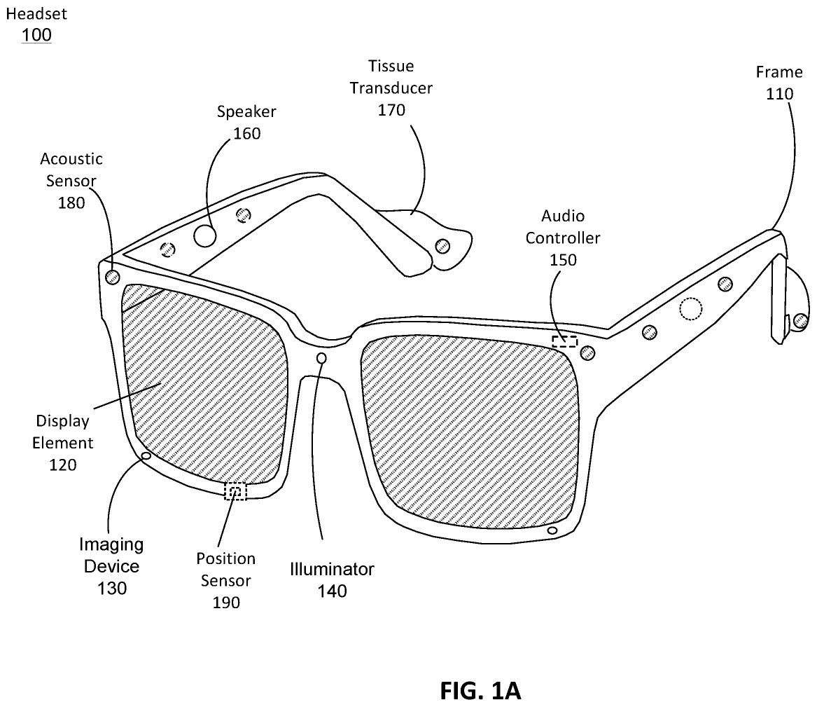

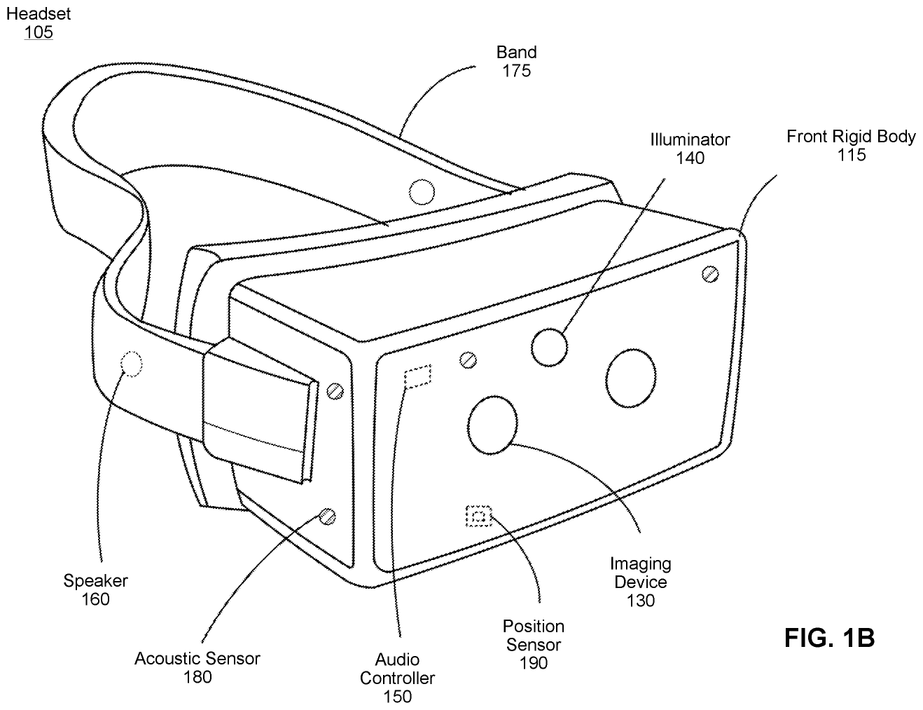

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame and one or more imaging devices 130, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

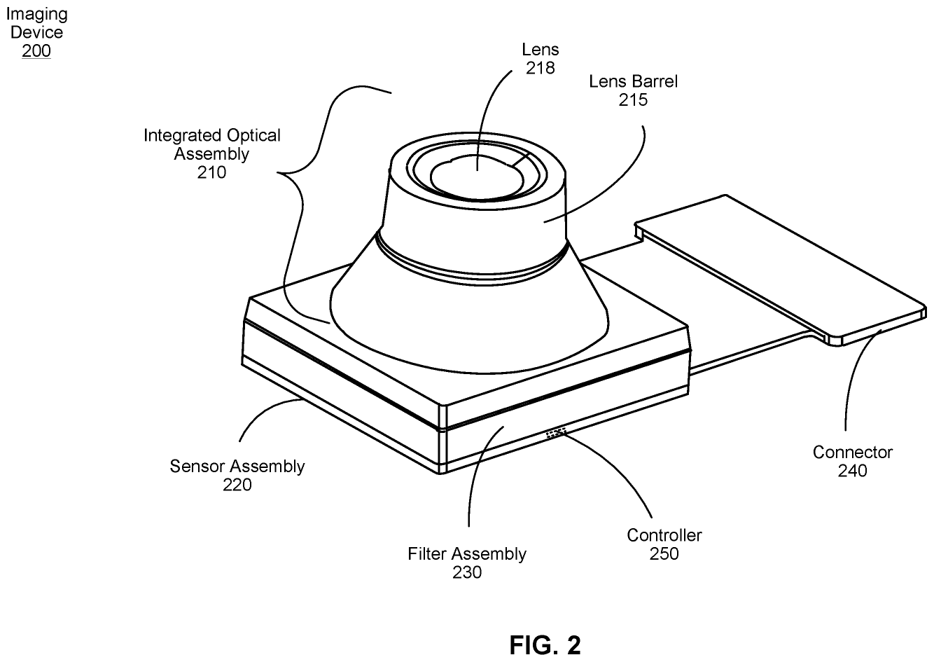

The one or more imaging devices 130 are configured to capture images from a local area of the headset 100. An imaging device includes a sensor assembly and an integrated optical assembly. The integrated optical assembly includes a lens barrel with one or more optical elements including at least one an integrated tunable lens. An optical element may be an active optical element or a passive optical element. A passive optical element does not use power. A passive optical element may be, e.g., a lens, an aperture, a filter, some other optical element that does not use power, or some combination thereof. An active optical element may use power. An active optical element may include, e.g., a tunable lens element, some other optical element that may use power, or some combination thereof. The lens barrel is configured to hold the one or more optical elements including at least one integrated tunable lens in optical series with each other within the lens barrel. For example, the lens barrel may be configured to hold one or more lenses and one or more tunable lenses in optical series with each other within the lens barrel. The one or more optical elements including the at least one integrated tunable lens focus the light on one or more sensors of the sensor assembly. The lens barrel includes one or more integrated electrodes that couple to some or all of the active optical elements (e.g., tunable lens element) within the lens barrel. The one or more integrated electrodes may communicatively couple active optical elements to a printed circuit board (PCB) that is communicatively coupled to a controller (e.g., on the PCB) that controls the one or more tunable lenses. The imaging device 130 is described in detail below with regard to, e.g., FIGS. 2-5.

The DCA determines depth information for a portion of a local area surrounding the headset 100. The DCA includes one or more of the imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

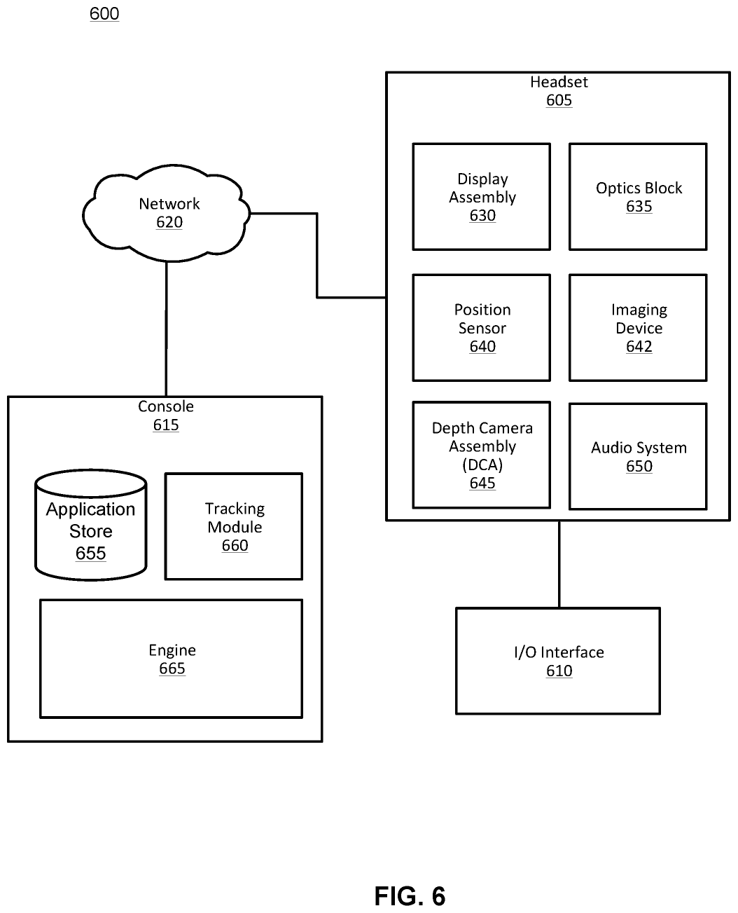

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 6.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 2 is a perspective view of an example imaging device 200 with an integrated optical assembly 210 having one or more integrated tunable lenses, according to one or more embodiments. The imaging device 200 is an example of a device that may be used as an imaging device 130 in headsets 100 and 105. The imaging device 200 includes the integrated optical assembly 210, and a sensor assembly 220, and optionally includes a filter assembly 230. Some embodiments of the imaging device 200 have different components than those described here. Similarly, in some cases, functions can be distributed among the components in a different manner than is described here. The imaging device 200 may be integrated into a device (e.g., headset 100) via a connector 240. As shown, the imaging device includes a controller 250 that controls the imaging device 200. In other embodiments, the controller 250 may be part of the device (e.g., headset) in which the imaging device is integrated. Moreover, in some cases the controller may deliver relatively high voltage, so placement within the imaging device 200 can help reduce ohmic voltage losses. For example, as shown, the controller 250 can be integrated on a same PCB as the sensor assembly 220.

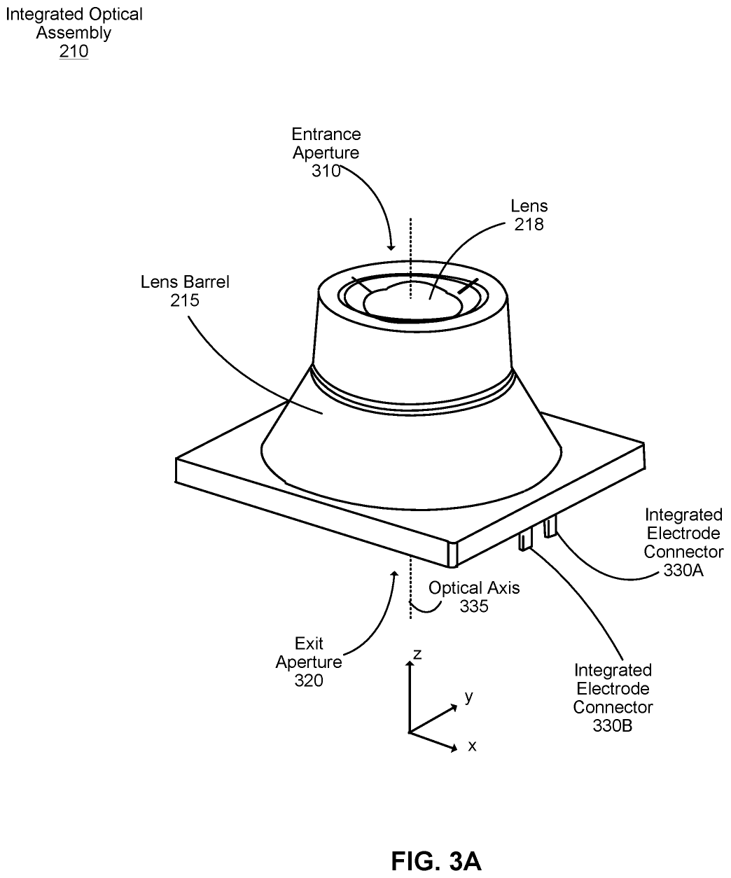

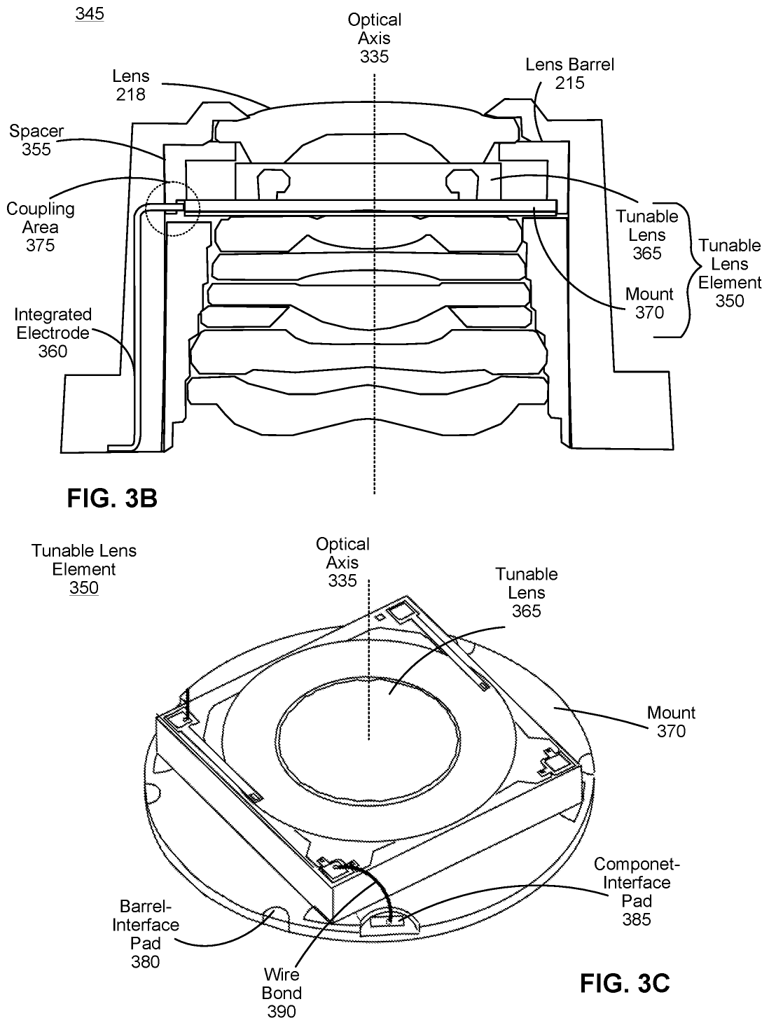

The integrated optical assembly 210 focuses light from a local area of the imaging device 200 onto one or more sensors of the sensor assembly 220. The integrated optical assembly 210 includes a lens barrel 215 and one or more optical elements (e.g., lens 218) that include at least one an integrated tunable lens element (not shown). The lens barrel 215 holds optical elements in optical series (i.e., arranged such that light passes sequentially through the optical elements one optical element at a time) with each other within the lens barrel 215. In some embodiments, the optical elements include one or more lenses and one or more tunable lens elements. The one or more lenses can be passive optical elements that each have a fixed optical power. The one or more tunable lens elements are active optical elements whose respective optical powers can be adjusted via application of an electric signal (may be referred to as an applied signal). For example, the one or more tunable lens elements may use the piezoelectric effect to adjust a curvature of a membrane to adjust optical power. The lens barrel 215 is described in detail below with regards to FIGS. 3A-5.

The lens barrel 215 includes a plurality of locations that may include locations for passive optical elements, locations for active optical elements, or some combination thereof. A location for an active optical element includes one or more coupling areas. A coupling area is a region at the location through which an active optical element can communicatively couple (e.g., electrical connection) with at least one of the integrated electrodes of the lens barrel 215. A contact area may be, e.g., a contact pad, a pin, a pin receptacle, etc. Note in some embodiments, there may be multiple locations for active optical elements, and at least one of the multiple locations for active elements may actually hold a passive optical element. In this manner, the same type of lens barrel 215 may be used to, e.g., form an integrated optical assembly with a tunable lens element in a first position, and also be used to form an integrated optical assembly with the tunable lens elements in a second position that is different than the first position.

The filter assembly 230 filters light received from the integrated optical assembly 210. The filter assembly 230 may include one or more band pass filters that together act to transmit light that is within a specific band and block light outside of the specific band. For example, the filter assembly 230 may be configured to block light in an infrared optical band and transmit light in a visible optical band. In another embodiment, the filter assembly 230 may be configured to transmit light in the infrared band (or a portion thereof) and block other light (e.g., light in the visible optical band).

The sensor assembly 220 is configured to detect light transmitted by the optical components within the integrated optical assembly 210 to the sensor assembly 220. The sensor assembly 220 includes one or more sensors that are sensitive to one or more optical bands of light. The one or more sensors may, be complementary metal-oxide semiconductor based, charge-coupled device based. In some embodiments, one or more of the sensors are event sensors.

The controller 250 controls the imaging device 200. The controller 250 is communicatively coupled to the sensor assembly 220 and the one or more tunable lenses. The controller 250 and the sensor assembly 220 may be mounted to a same PCB. Signals from the controller 250 may be applied to the one or more tunable lenses via one or more integrated electrodes that communicatively couple the one or more active optical elements (e.g., tunable lenses) to the PCB the sensor assembly 220 is mounted on. The one or more integrated electrodes are discussed in detail below with regard to FIGS. 3A-5.

FIG. 3A is a perspective view of the integrated optical assembly 210 of FIG. 2. The integrated optical assembly 210 includes the lens barrel 215 that holds optical elements (e.g., the lens 218) in optical series with each other within the lens barrel 215. Some embodiments of the integrated optical assembly 210 have different components than those described here. Similarly, in some cases, functions can be distributed among the components in a different manner than is described here.

The lens barrel 215 is configured to hold the optical elements (including at least one tunable lens element and the lens 218) in optical series with each other along an optical axis 335. As illustrated the lens barrel 215 may be monolithic (e.g., a single piece of material, multiple piece of a material that have fused together). The lens barrel 215 may be composed from, e.g., an injection molded plastic resin. In some embodiments the resin is a laser direct structuring (LDS) grade resin. The lens barrel 215 has an entrance aperture 310 and an exit aperture 320. Light passes through the entrance aperture 310 to the optical elements and exits from the optical elements via the exit aperture 320 towards a sensor assembly (e.g., the sensor assembly 220). As illustrated portions of the lens barrel 215 have a circular cross section (in x and y dimensions). The rotational symmetry of the lens barrel 215 and lens mount 370 (see FIG. 3B) is beneficial as it reduces thermal stresses on the lens mount 370, resulting in improved performance compared to some other designs, such as a square shape or non-symmetrical design.

In other embodiments, some or all of the lens barrel 215 may have a different shaped cross section. Some or all of an interior surface (not shown) of the lens barrel 215 may be coated with an anti-reflective coating (e.g., to help reduce stray light).

The lens barrel 215 includes one or more integrated electrodes. In some embodiments, the integrated electrodes can be fabricated by metal insert molding. Part or all of the electrodes may be embedded into the lens barrel body. In the illustrated embodiment there are two integrated electrodes. Note in FIG. 3A the integrated electrodes are not visible, as they each have a pathway below an exterior surface of the lens barrel 215 from their respective connector (i.e., integrated electrode connector 330A and integrated electrode connector 330B) to a contact area for a tunable lens element.

In other embodiments (not shown), some or all of the integrated electrodes may be applied to the exterior surface of the lens barrel 215. For example, the lens barrel 215 may include one or more holes that connect an interior surface of the lens barrel 215 to the exterior surface of the lens barrel 215. The one or more holes may be filled with conductive material of the one or more integrated electrodes.

The optical elements are configured to provide light from a local area to a sensor assembly (e.g., the sensor assembly 220). The optical elements may include one or more lenses and one or more tunable lens elements. In FIG. 3A, the optical elements include at least the lens 218 and one or more tunable lens elements. The optical elements are in optical series with each other along the optical axis 335. Passive optical elements may include lenses that each have a fixed optical power.

A tunable lens element adjusts its optical power in accordance with an electric signal applied from one or more integrated electrodes. A tunable lens element includes a tunable lens and a mount. The tunable lens is affixed to and communicatively coupled to the mount and is configured to adjust its optical power in accordance with an applied signal. In some embodiments, there may be two tunable lenses affixed to a single mount (e.g., one on either side of the mount). The one or more tunable lens elements include tunable lenses that are active optical elements whose respective optical powers can be adjusted via application of an electric signal. A tunable lens is any lens that can vary its optical power as a function of an applied electric signal. For example, a tunable lens may be an electro-optical tunable lens based on electro-wetting, may be based on electro-mechanical techniques (e.g., using piezoelectric effect to change membrane curvature), may be based on acousto-optical techniques, etc. A tunable lens is configured to adjust its optical power over a range of optical power (e.g., 0 to 5 diopters, 0 to −5 diopters, etc.). In cases where there are multiple tunable lenses, the range of optical power for each tunable lens may be the same. In other embodiments, at least one of the tunable lenses has a range of optical power that is different from at least one other tunable lens. For example, one tunable lens may have a range of optical powers that is positive (e.g., 0 to 5 diopters) and another may have a range of optical powers that is negative (e.g., 0 to −5 diopters). In some embodiments, a tunable lens may be configured such that when no voltage is applied it still provides some amount of optical power.

The mount of the tunable lens element provides structural support for the tunable lens, and is shaped to fit within a location in the lens barrel 215 for an active optical element. The mount may be made from various materials, such as a flexible printed circuit board (FPCB), molding plastics, or the same material as the lens barrel 215. In some embodiments, a material of the mount has a small coefficient of thermal expansion (CTE). The mount may be rotationally symmetric, such as having a circular cross-section. In some embodiments, the mount may be opaque to light in an optical band of the one or more sensors of a sensor assembly (e.g., the sensor assembly 220). The mount may include an aperture centered on the optical axis 335 that allows light to pass through the tunable lens element (e.g., toward the exit aperture 320). In other embodiments, the mount may be transparent to light in an optical band of the one or more sensors of the sensor assembly, and in some cases instead of an aperture centered on the optical axis 335, the light passes through the mount toward the exit aperture 320. The mount may include a plurality of pads and traces that are used to communicatively (i.e., electrically) couple a tunable lens of a tunable lens element to one or more integrated electrodes at coupling areas of the lens barrel 215. In some embodiments, the pads may be coupled to the coupling area via electrically conductive adhesive. In some embodiments, the mount may communicatively couple to one or more integrated electrodes via some other means (e.g., pins).

In some embodiments, the one or more integrated electrodes communicatively couple the one or more tunable lenses elements to a PCB. The PCB may be coupled to a controller (e.g., the controller 250) which can supply the signals to control the optical power of the one or more tunable lenses. While the illustrated embodiment includes two integrated electrodes, in other embodiments there may be less or more integrated electrodes. In FIG. 3A, the two integrated electrodes are conductive traces that are under an exterior surface of the lens barrel 215. In some embodiments, a first set of two integrated electrodes are configured to actuate the lens and another set of two integrated electrodes are configured to measure a capacitance, such that deformation of the lens (or optical power) can be detected. The one or more integrated electrodes are electrical conductors, and may be composed from, e.g., gold, silver, copper, aluminum, etc. The conductive trace of an integrated electrode may be implemented under the exterior surface of the lens barrel 215 via various processes. In some embodiments, the integrated electrodes under the exterior surface of the lens barrels 215 can be fabricated by metal insert molding. In some embodiments, all of the integrated electrodes can be embedded into the lens barrel body through metal insert molding. Alternatively, in some embodiments, a subset of the integrated electrodes are fabricated by metal insert molding, while another subset of the integrated electrodes are fabricated by LDS process. In some embodiments, coupling area 375 is fabricated by metal through metal insert molding, which can result in better control of the contact interface than LDS process.

In other embodiments (not shown), some or all of the integrated electrodes are conductive traces that are applied to an exterior surface of the lens barrel 215. For example, an integrated electrode may include at least one via and a conductive trace (that is applied to the exterior surface of the lens barrel 215). The via is a conductive material that fills a hole in the lens barrel 215. For example, a via may be used to couple a tunable lens element that is within the lens barrel 215 to conductive trace of an integrated electrode. The conductive trace of an integrated electrode may be implemented directly on the exterior surface of the lens barrel 215 via a LDS process. Some layouts of the one or more integrated electrodes are described below with regard to, e.g., FIGS. 3B and 3C.

FIG. 3B is a cross section 345 of the lens barrel 215 of FIG. 3A. As illustrated the lens barrel 215 includes a plurality of lenses (e.g., lens 218) and a tunable lens element 350. Note in other embodiments, there may be different types of lenses, different numbers of lenses, more tunable lenses, etc. Likewise, in other embodiments, the tunable lens element 350 may be placed in different locations within the lens barrel 215. The lenses and the tunable lens element 350 are in optical series along the optical axis 335, and are separated from adjacent optical components via spacers (e.g., spacer 355). The tunable lens element 350 includes a tunable lens 365 and a mount 370. The tunable lens element 350, the tunable lens 365, and the mount 370 are embodiments of the tunable lens element, the tunable lens, and the mount described above with regard to, e.g., FIG. 3A. The integrated electrode 360 communicatively couples to the tunable lens element 350 via the mount 370 in a coupling area 375. Note while a single integrated electrode and coupling area are shown the cross section 345, other coupling areas and integrated electrodes are present, but are just not visible in the cross section 345. The integrated electrode 360 may be coupled to the mount 370 in the coupling area 375 using, e.g., a conductive adhesive, pins, solder, some other means of establishing an electrical connection, or some combination thereof. In some embodiments, some or all of the lenses, the tunable lens element 350, and the spacers, are further fixed in place with an adhesive.

FIG. 3C is a perspective view of the tunable lens element 350, according to one or more embodiments. A soft and thick adhesive and/or double side tapes may be used to attach the lens 365 to the mount 370. In one embodiment, a thickness of the tape or adhesive is greater than 20 um to reduce stress applied to the lens due to variance of the thickness of the lens 365 or mount 370. An elastic modulus of the adhesive or tape may be less than 50 mPa. The adhesive or tape can be applied to symmetric locations on the lens 365, such as the four corners of the lens. As noted above, the tunable lens element 350 includes the tunable lens 365 and the mount 370. The tunable lens 365 is affixed to and communicatively coupled to the mount 370 and is configured to adjust its optical power in accordance with an applied signal.

The mount 370 provides structural support for the tunable lens 365. In the illustrated embodiment, the mount 370 is a FPCB. In other embodiments, it may be some other material. In some embodiments, the mount 370 includes an aperture (not shown) that is centered on the optical axis 335. The aperture may be sized to allow light to pass through the tunable lens towards an exit aperture (e.g., the exit aperture 320) without vignetting (clipping). The mount 370 includes a plurality of pads and traces (not shown).

The plurality of pads and traces may be used to communicatively (i.e., electrically) couple the tunable lens 365 to one or more integrated electrodes (e.g., the integrated electrode 360) at a coupling area (e.g., the coupling area 375) of the lens barrel 215. In the illustrated example, the plurality of pads is either barrel-interface pads (e.g., barrel-interface pad 380) or component-interface pads (e.g., component-interface pad 385). In other embodiments (not shown), some or all of the plurality of pads function as both a barrel-interface pad and a component-interface pad. The barrel-interface pads are communicatively coupled via one or more traces (not shown) on the mount 370 to one or more corresponding component-interface pads. For example, the barrel-interface pad 380 is communicatively coupled to the component-interface pad 385 via one or more traces (not shown). The traces may be internal to the mount 370, on an exterior surface of the mount, or some combination thereof. A barrel-interface pad may be communicatively coupled to an integrated electrode, and its corresponding component-interface pad(s) may be communicatively coupled to the tunable lens 365. For example, the component-interface pad 385 is communicatively coupled to the tunable lens via a wire bond 390. It is advantageous to use wire bond 390 because, given the lens's high sensitivity to stresses, wire bonding exerts less stress on the lens once the bonding process is finished. In this manner, an applied signal may be provided to the tunable lens 365, via a conductive pathway formed by an integrated electrode, the barrel-interface pad 380, one or more traces, the component-interface pad 385, and the wire bond 390. Note that while a single conductive pathway is described above, in the embodiment illustrated in FIG. 3C there are two conductive pathways shown. And in other embodiments, there may be more or less conductive pathways to the tunable lens 365.

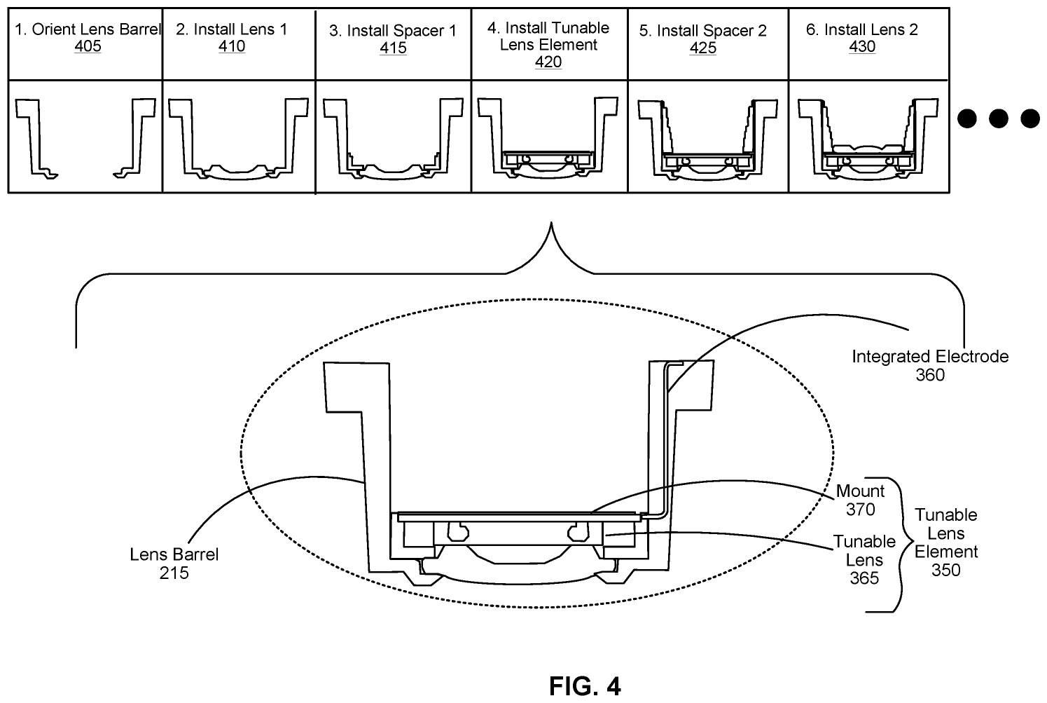

FIG. 4 is an example process for assembling the integrated optical assembly 210 of FIG. 3A. The process shown in FIG. 4 may be performed by, e.g., a lens barrel manufacturing system (LBM system). Other entities may perform some or all of the steps in FIG. 4 in other embodiments. Embodiments may include different and/or additional steps, or perform the steps in different orders.

The LBM system orients 405 a lens barrel (e.g., the lens barrel 215), and installs 410 a first lens (Lens 1) in the lens barrel. The LBM system installs 415 a spacer (Spacer 1) along some or all of the periphery of Lens 1 in the lens barrel. The LBM system then installs 420 a tunable lens element (e.g., the tunable lens element 350). As part of 420 the LBM system electrically couples a mount (e.g., the mount 370) of the tunable lens element 350 to one or more integrated electrodes (e.g., the integrated electrode 360). For example, the LBM system may use a conductive adhesive to electrically couple the mount to the one or more integrated electrodes. The LBM system installs 425 a spacer (Spacer 2) along some or all of the periphery of tunable lens element in the lens barrel. The LBM system repeats the process of lens installation (e.g., step 430) followed by an associated spacer until all of the optical elements have been installed in the lens barrel. In some embodiments, an adhesive may be used to help secure lenses, the tunable lens element, spacers, or some combination thereof, in the lens barrel. Note that the interior surface of the body is shaped such that each optical element within it (e.g., lens, tunable lens) is positioned such that they are in correct alignment. This results in less time spent on alignment than in conventional camera systems that have a tunable lens outside of the lens barrel.

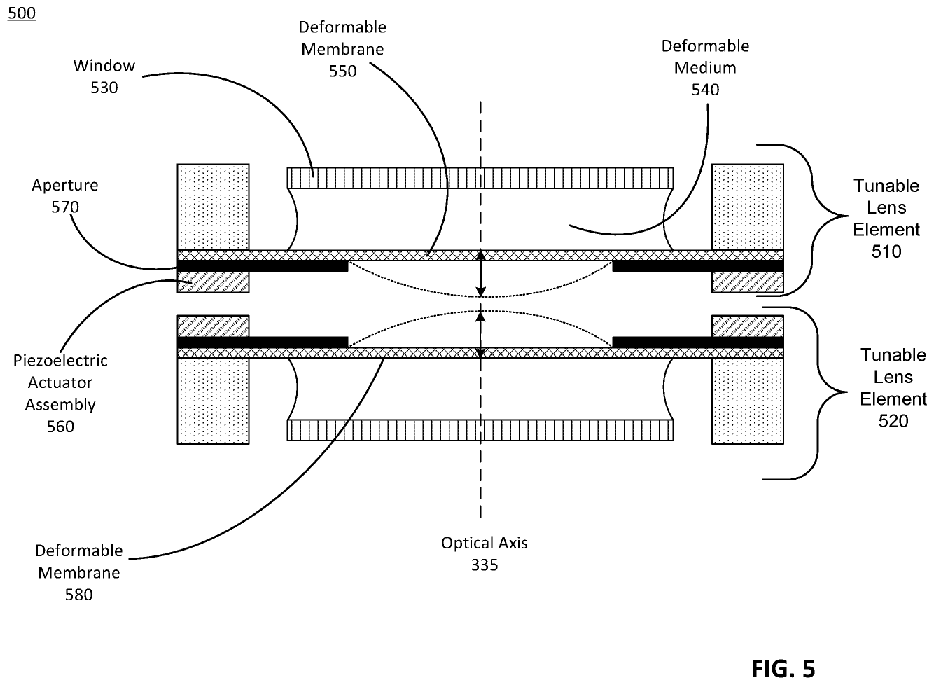

FIG. 5 is an example configuration 500 of tunable lens elements that have a range of optical powers that includes both negative and positive values, according to one or more embodiments. The configuration 500 may be integrated into a lens barrel (e.g., the lens barrel 215) to provide, e.g., a larger range of optical power adjustment than a single tunable lens element can provide. The configuration 500 includes a tunable lens element 510 and a tunable lens element 520. The tunable lens element 510 and the tunable lens element 520 are embodiments of the tunable lens element described above with regard to FIGS. 2-4. The tunable lens element 510 and the tunable lens element 520 are in optical series with each other along the optical axis 335. As illustrated the tunable lens element 520 is substantially the same as the tunable lens element 510, but is inverted relative to the tunable lens element 510. Accordingly, the tunable lens element 510 would have a positive range of optical power (e.g., 0 to +N diopters, where N number that is greater than or equal to zero) and the tunable lens element 520 would have a negative range of optical power (e.g., 0 to −N). Note in alternate embodiments the tunable lens element 510 may differ from the tunable lens element 520 such that they have different ranges of optical power (e.g., 0 to +N and 0 to −0.5 N, respectively). Likewise, in alternate embodiments, the tunable lens element 520 may not be inverted relative the tunable lens element 510.

The tunable lens element 510 is configured to adjust its optical power in accordance with an applied signal (e.g., an electric signal). The tunable lens element 510 includes a window 530, a deformable medium 540 (e.g., polymer), a deformable membrane 550 (e.g., deformable glass membrane), a piezoelectric actuator assembly 560, and optionally includes an aperture 570. The piezoelectric actuator assembly 560 incudes one or more piezoelectric actuators that control a surface profile of the deformable membrane 550 responsive to receiving an electrical signal (e.g., via an integrated electrode). As illustrated the tunable lens element 510 (and the tunable lens element 520) are in a first position in which the deformable membrane 550 is substantially flat (0 diopters). However, responsive to a received electrical signal the piezoelectric actuator assembly 560 applies one or more forces to the deformable membrane 550 to cause it to bend toward the tunable lens element 520 introducing curvature into the surface profile of the deformable membrane 550. In this manner, the tunable lens element 510 is able to dynamically adjust its optical power from zero up to +N diopters.

As noted above, the tunable lens element 520 is substantially the same as the tunable lens element 510, but it inverted relative to the tunable lens element 510. Accordingly, application of an electric signal to the tunable lens element 520 (via its piezoelectric actuator assembly) causes a deformable membrane 580 to bend toward the tunable lens element 510 introducing curvature into a surface profile of the deformable membrane 580. In this manner, the tunable lens element 520 is able to dynamically adjust its optical power from zero down to −N diopters. Accordingly, the configuration 500 as shown has an optical range of (−N to +N) diopters.

FIG. 6 is a system 600 that includes a headset 605, in accordance with one or more embodiments. In some embodiments, the headset 605 may be the headset 100 of FIG. 1A or the headset 105 of FIG. 1B. The system 600 may operate in an artificial reality environment (e.g., a virtual reality environment, an augmented reality environment, a mixed reality environment, or some combination thereof). The system 600 shown by FIG. 6 includes the headset 605, an input/output (I/0) interface 610 that is coupled to a console 615, and the network 620. While FIG. 6 shows an example system 600 including one headset 605 and one I/O interface 610, in other embodiments any number of these components may be included in the system 600. For example, there may be multiple headsets each having an associated I/0 interface 610, with each headset and I/O interface 610 communicating with the console 615. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the console 615 may be provided by the headset 605.

The headset 605 includes the display assembly 630, an optics block 635, one or more position sensors 640, one or more imaging devices 642, a DCA 645, and an audio system 650. Some embodiments of headset 605 have different components than those described in conjunction with FIG. 6. Additionally, the functionality provided by various components described in conjunction with FIG. 6 may be differently distributed among the components of the headset 605 in other embodiments, or be captured in separate assemblies remote from the headset 605.

The display assembly 630 displays content to the user in accordance with data received from the console 615. The display assembly 630 displays the content using one or more display elements (e.g., the display elements 120). A display element may be, e.g., an electronic display. In various embodiments, the display assembly 630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 635.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUs, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The one or more imaging devices 642 are configured to capture images from a local area of the headset 605. The one or more imaging devices 642 are embodiments of the imaging device described above with reference to, e.g., FIGS. 1A-5. An imaging device 642 includes an integrated optical system with a lens barrel and one or more tunable lens elements. The lens barrel may be configured to hold one or more optical elements (e.g., passive optical elements, active optical elements, or some combination thereof) that include at least one tunable lens element in optical series with each other within the lens barrel. The one or more optical elements that include the at least one tunable lens element focus light on one or more sensors of an imaging device. The lens barrel includes one or more integrated electrodes that couple to one or more tunable lens elements. The one or more integrated electrodes may couple the one or more tunable lens elements to a PCB that is communicatively coupled to a controller that controls the one or more tunable lenses.

The DCA 645 generates depth information for a portion of the local area. The DCA includes one or more imaging devices and a DCA controller. The DCA 645 may also include an illuminator. Operation and structure of the DCA 645 is described above with regard to FIG. 1A.

The audio system 650 provides audio content to a user of the headset 605. The audio system 650 may be substantially the same as the audio system described above with regard to FIG. 1A. The audio system 650 may comprise one or acoustic sensors, one or more transducers, and an audio controller. The audio system 650 may provide spatialized audio content to the user. The acoustic parameters describe one or more acoustic properties (e.g., room impulse response, a reverberation time, a reverberation level, etc.) of the local area. The audio system 650 may provide information describing at least a portion of the local area from e.g., the DCA 645 and/or location information for the headset 605 from the position sensor 640.

The I/O interface 610 is a device that allows a user to send action requests and receive responses from the console 615. An action request is a request to perform a particular action. For example, an action request may be an instruction to start or end capture of image or video data, or an instruction to perform a particular action within an application. The I/O interface 610 may include one or more input devices. Example input devices include: a keyboard, a mouse, a game controller, or any other suitable device for receiving action requests and communicating the action requests to the console 615. An action request received by the I/O interface 610 is communicated to the console 615, which performs an action corresponding to the action request. In some embodiments, the I/O interface 610 includes an IMU that captures calibration data indicating an estimated position of the I/O interface 610 relative to an initial position of the I/O interface 610. In some embodiments, the I/O interface 610 may provide haptic feedback to the user in accordance with instructions received from the console 615. For example, haptic feedback is provided when an action request is received, or the console 615 communicates instructions to the I/O interface 610 causing the I/O interface 610 to generate haptic feedback when the console 615 performs an action.

The console 615 provides content to the headset 605 for processing in accordance with information received from one or more of: the DCA 645, the headset 605, and the I/O interface 610. In the example shown in FIG. 6, the console 615 includes an application store 655, a tracking module 660, and an engine 665. Some embodiments of the console 615 have different modules or components than those described in conjunction with FIG. 6. Similarly, the functions further described below may be distributed among components of the console 615 in a different manner than described in conjunction with FIG. 6. In some embodiments, the functionality discussed herein with respect to the console 615 may be implemented in the headset 605, or a remote system.

The application store 655 stores one or more applications for execution by the console 615. An application is a group of instructions, that when executed by a processor, generates content for presentation to the user. Content generated by an application may be in response to inputs received from the user via movement of the headset 605 or the I/O interface 610. Examples of applications include: gaming applications, conferencing applications, video playback applications, or other suitable applications.

The tracking module 660 tracks movements of the headset 605 or of the I/O interface 610 using information from the DCA 645, the one or more position sensors 640, or some combination thereof. For example, the tracking module 660 determines a position of a reference point of the headset 605 in a mapping of a local area based on information from the headset 605. The tracking module 660 may also determine positions of an object or virtual object. Additionally, in some embodiments, the tracking module 660 may use portions of data indicating a position of the headset 605 from the position sensor 640 as well as representations of the local area from the DCA 645 to predict a future location of the headset 605. The tracking module 660 provides the estimated or predicted future position of the headset 605 or the I/0 interface 610 to the engine 665.

The engine 665 executes applications and receives position information, acceleration information, velocity information, predicted future positions, or some combination thereof, of the headset 605 from the tracking module 660. Based on the received information, the engine 665 determines content to provide to the headset 605 for presentation to the user. For example, if the received information indicates that the user has looked to the left, the engine 665 generates content for the headset 605 that mirrors the user's movement in a virtual local area or in a local area augmenting the local area with additional content. Additionally, the engine 665 performs an action within an application executing on the console 615 in response to an action request received from the I/O interface 610 and provides feedback to the user that the action was performed. The provided feedback may be visual or audible feedback via the headset 605 or haptic feedback via the I/O interface 610.

The network 620 couples the headset 605 and/or the console 615. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g., Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. An integrated optical assembly comprising:
a tunable lens element including:
a mount; and
a tunable lens that is affixed to and communicatively coupled to the mount and is configured to adjust its optical power in accordance with an applied signal; and
a lens barrel configured to hold the tunable lens element in optical series with at least one other optical element within the lens barrel, the lens barrel including an integrated electrode that communicatively couples the mount to a controller which supplies the applied signal.

2. The integrated optical assembly of claim 1, wherein the lens barrel is monolithic.

3. The integrated optical assembly of claim 1, wherein the at least one other optical element includes a first lens and a second lens, and the tunable lens element is positioned between the first lens and the second lens.

4. The integrated optical assembly of claim 1, wherein the mount is a flexible printed circuit board (FPCB).

5. The integrated optical assembly of claim 4, wherein the FPCB is communicatively coupled to the tunable lens with a wire bond.

6. The integrated optical assembly of claim 1, wherein the integrated electrode comprises:
a conductive trace under an exterior surface of the lens barrel that communicatively couples the mount to a printed circuit board (PCB) that is coupled to the controller.

7. The integrated optical assembly of claim 1, wherein the integrated electrode comprises:
a conductive trace applied to an exterior surface of the lens barrel that communicatively couples the mount to a printed circuit board (PCB) that is coupled to the controller.

8. The integrated optical assembly of claim 1, wherein the tunable lens is configured to adjust its optical power over a first range of optical power, and the integrated optical assembly further comprises:
a second tunable lens within the lens barrel, the second tunable lens in optical series with the tunable lens, and the second tunable lens is configured to adjust its optical power over a second range of optical power in accordance with a second applied signal.

9. The integrated optical assembly of claim 8, wherein the first range of optical power describes a positive range of optical power, and the second range of optical power describes a negative range of optical power.

10. A lens barrel configured to hold an optical element and a tunable lens element in optical series with each other within the lens barrel, the lens barrel including an integrated electrode, wherein the integrated electrode is configured to communicatively couple a mount of the tunable lens element to a controller that controls a tunable lens of the tunable lens element.

11. The lens barrel of claim 10, wherein a body of the lens barrel is monolithic.

12. The lens barrel of claim 10, wherein the lens barrel is further configured to hold a second optical element, and hold the tunable lens between the optical element and the second optical element.

13. The lens barrel of claim 10, wherein the integrated electrode comprises a conductive trace under an exterior surface of the lens barrel.

14. The lens barrel of claim 10, wherein the integrated electrode comprises a conductive trace applied to an exterior surface of the lens barrel.

15. An imaging device comprising:
a lens;
a tunable lens element, the tunable lens element including a tunable lens that is affixed to and communicatively coupled to a mount and is configured to adjust its optical power in accordance with an applied signal;
a sensor assembly; and
a lens barrel configured to hold the lens and the tunable lens element in optical series with each other within the lens barrel such that light passing through the lens and the tunable lens focuses on the sensor assembly, the lens barrel including an integrated electrode that communicatively couples the mount to a controller which supplies the applied signal.

16. The imaging device of claim 15, wherein a body of the lens barrel is monolithic.

17. The imaging device of claim 15, further comprising:
a second lens;
wherein the tunable lens element is positioned between the lens and the second lens.

18. The imaging device of claim 15, wherein the integrated electrode comprises:
a conductive trace under an exterior surface of the lens barrel that communicatively couples the mount to the controller.

19. The imaging device of claim 15, wherein the integrated electrode comprises:
a conductive trace applied to an exterior surface of the lens barrel that communicatively couples the mount to the controller.

20. The imaging device of claim 15, wherein the tunable lens is configured to adjust its optical power over a first range of optical power, and the imaging device further comprises:
a second tunable lens element within the lens barrel, the second tunable lens element including a second tunable lens that is affixed to and communicatively coupled to a second mount and is configured to adjust its optical power over a second range of optical power in accordance with a second applied signal.
